(19) United States
(12) Patent Application Publication
(10) Pub. No.: US 2007/0113795 A1
(43) Pub. Date: May 24, 2007

(54) Tangle-Free Vacuum Comb

(76) Inventor: Hanna Yaacoub Hajjar, Tarzana, CA (US)

Correspondence Address: Mr.Hanna Yaacoub Hajjar, 6258 Calvin Ave., Tarzana, CA, 91335, US

(21) Appl. No.: 11/164,399

(22) Filed: Nov. 21, 2005

(51) Int. Cl. A01K 13/00

(52) U.S. Cl. 119/608

(57) ABSTRACT

The Tangle-Free Vacuum Comb consists of a one row rigid (or semi rigid) comb with a hollow housing, and hollow rigid handle, forming the passage ways of a vacuum attachment head. This is connected to the end of a vacuum hose, and when the vacuum is powered, suction is generated at the edge of the comb, drawing in any loose hair/fur and dander while combing an animal. Offering a quick and efficient animal grooming where loose hair and dandruff is sucked into the vacuum bag or container, which is disposed off neatly. It can be dimensioned to fit the vacuum hoses of standard vacuum cleaners or smaller portable ones.

### FIELD OF THE INVENTION

The present invention relates to a new way of making a vacuum comb attachment heads for using as a hand tool for combing, grooming, and cleaning hairy or furry animals. More particularly, the present invention utilizes a standard household vacuum to generate the suction power needed through the hollow passages of the hand held Vacuum Comb tool that simultaneously combs, dislodges loose hair and dandruff, which in turn is drawn into the vacuum bag or container, and is disposed off later, leading to a healthy and clean animal, a house free of loose animal hair, and reducing airborne indoor air pollution by eliminating animal dandruff.

### BACKGROUND INFORMATION

Almost all animals shed their hair, and some have a peak shedding during certain month(s) of the year. In the wild, animals shed their hair naturally, and loose hair outdoor is not a menace to anyone, but once animals were domesticated, tamed and turned into pets or work animals, the necessity of animal grooming became an essential task to humans that raise them. Hence animal grooming is as ancient as the interaction between man and animals, animal grooming was practiced by many ancient civilizations, ancient artifacts and manuscripts show and describe how men brushed their horses, and how temple people groomed certain animals for certain religious rituals. As animals were moved indoors as pets, the problem of animal hair shedding became a problem to pet owners. To mitigate this problem a simple brush or comb was used, but this process is not efficient since it requires constant cleaning of the brush or comb since pet hair gets entangled in the brush's bristles or the comb's teeth, and on top of that there is always the fall out of pet hair as brushing is performed or as the pet shakes itself and moves around the house, so a grooming session is always followed by floor cleaning.

The old fashioned comb or brush is not an efficient way to groom an animal or a pet, because although they mitigate the problem yet they don't control it efficiently, because they don't pick most of the loose hair, leading to more labor by the person conducting the grooming, not only removing the hair from the pet, but also cleaning the hair fallout on the floor and/or on furniture after grooming.

U.S. Pat. No. D444,924 issued on Jul. 10, 2001, to Henning, Mary Lou. The problem with this design is that flow direction is perpendicular to the back of the brush, and that causes the animals hair to get entangled in between the multi rows brush teeth, blocking the way and reducing its efficiency.

U.S. Pat. No. D389,618 issued on Jan. 20, 1998, to Rosen, Catherine B. This design is a brush handle vacuum head, the problem with this design is that the brush consists of several rows of bristles, and the vacuum inlet is placed at one side almost perpendicular to the bristles, this arrangement causes hair collected by the back rows of the bristles to get entangled around the bristles that are closer to vacuum hose inlet, hence blocking the way and reducing its efficiency.

U.S. Pat. No. 4,799,460 issued on Jan. 24, 1989, Kuhl, Lynn. Is a self contained small vacuum unit with a two rows circular brush the problem with this design is that hair gets entangled between the two rows of brush bristles, hence blocking the way and reducing its efficiency.

As we see from Prior Art, the problem of having hair/fur getting tangled between comb teeth and brush's bristles is a major problem with classical combs and brushes as well as prior vacuum operated grooming attachment heads, and even a two rows comb with a zigzag shaped comb teeth arrangement would still get long hair entangled, and worst of all are bushes with multi-bristles that are grouped together, where hair is locked between them. And any tool that causes entangling of hair/fur, leads to more cleaning labor by the user as in the case of classical combs and brushes, and also a drop in the efficiency of vacuum operated ones, leading to the choking of the vacuum suction through blockage of the vacuum passage ways, consequently rendering that tool useless.

Thus, an improved method of animal grooming is necessary, and a new system of animal loose hair removal is needed, a Tangle-Free Vacuum Comb.

### OBJECTS AND ADVANTAGES

For the purpose of this patent application, the term Tangle-Free Vacuum Comb is defined as an attachment head consisting of a rigid comb with vacuum passage ways coupled with hollow tubing forming a suction mouth piece with a handle, which is then attached to the end of the flexible vacuum hose of a regular household vacuum by friction the similar to any vacuum had attachment. This attachment head is hand held and glided over the skin of an animal in the manner of a comb; the comb dislodges any loose hair, while the vacuum pump creates a suction force that sucks that loose pet hair and dandruff through its hose, which is then collected inside its bag or container.
(1) The unique feature of the Vacuum Comb is that it is unlike the classical vacuum head attachments, it has a unique look due to being a special shaped vacuum head with a rigid comb that functions like a rake with suction.
(2) The main unique feature about the Vacuum Comb is that it solves the problem of hair getting entangled to the brush bristles or comb teeth. By having the vacuum inlet perpendicular to the comb teeth of a single row comb (forming the shape of a “T”), and in a way where the hair is collected between the comb teeth and the vacuum inlet, this way all hair is sucked into the vacuum hose without getting entangled on the teeth, hence no blocking of passageways, this feature allows it to function very efficiently, making this layout ideal for long hair animals.
(3) With the Vacuum Comb constantly moving, and making use of the full length of the comb, a larger skin surface area is covered in a short time, and hence a full grooming is given in a very short time, making it a time saving tool.
(4) The Vacuum Comb's heads can be easily interchanged, to offer different uses or effects; a perpendicular T-Shaped Angle Vacuum Comb is ideal for long hair animals, while an in-Line Vacuum Comb is good for short hair animals.
(5) The Vacuum Comb is very easy to attach to a standard diameter vacuum hose, and with adapters it can be used on different smaller size portable vacuums. All it takes is pushing the end of a vacuum hose into the comb attachment head's end, and that locks it in place by friction.
(6) Vacuum Comb can be made of very cost effective material like plastic.

### BRIEF DESCRIPTION OF THE DRAWINGS

The present invention is illustrated by a way of example in the following drawings in which references indicate similar elements. The following drawings disclose various embodiments of the invention for the purpose of illustration only and are not indeed to limit the scope of the invention.

FIG. 1 illustrates few Different types of Vacuum Combs and Extensions in perspective.

FIG. 1A illustrates angle vacuum comb without a transition end.

FIG. 1B illustrates angle vacuum comb with a transition end.

FIG. 1C illustrates in-line vacuum comb without a transition end.

FIG. 1D illustrates in-line vacuum comb with a transition end.

FIG. 1E illustrates extension vacuum comb without a transition end.

FIG. 1F illustrates extension vacuum comb with a transition end.

FIG. 2 illustrates an in-Line Vacuum Comb attachment head.

FIG. 2A illustrates a side view of an in-line vacuum comb.

FIG. 2B illustrates a bottom view of an in-line vacuum comb.

FIG. 2C illustrates a top view of an in-line vacuum comb.

FIG. 2D illustrates a front view of an in-line vacuum comb.

FIG. 2E illustrates a back view of an in-line vacuum comb.

FIG. 3 illustrates Perpendicular, or an Angle Vacuum Comb attachment head.

FIG. 3A illustrates a top view of an angle vacuum comb.

FIG. 3B illustrates the side view of an angle vacuum comb.

FIG. 3C illustrates the bottom view of an angle vacuum comb.

FIG. 3D illustrates the front view of an angle vacuum comb.

FIG. 3E illustrates the back view of an angle vacuum comb.

FIG. 4 illustrates Vacuum Comb Adapters transition connections.

FIG. 4A illustrates a coupler adapter vacuum comb.

FIG. 4B illustrates an internal reducer adapter vacuum comb.

FIG. 4C illustrates an external reducer adapter vacuum comb.

FIG. 4D illustrates an enlarger adapter vacuum comb.

FIG. 5 illustrates Vacuum Comb Extensions attachments.

FIG. 5A illustrates a side view of an extension vacuum comb with transition end.

FIG. 5B illustrates a bottom view of an extension vacuum comb with transition end.

FIG. 5C illustrates a side view of an extension vacuum comb without transition end.

FIG. 5D illustrates a bottom view of an extension vacuum comb without transition end.

FIG. 5E illustrates a front view of an extension vacuum comb with transition end.

FIG. 5F illustrates a back view of an extension vacuum comb with transition end.

FIG. 5G illustrates a front view of an extension vacuum comb without transition end.

FIG. 5H illustrates a back view of an extension vacuum comb without transition end.

FIG. 6 illustrates Side Views of Vacuum Combs Variations.

FIG. 6A illustrates an angle vacuum comb with angled handle.

FIG. 6B illustrates an in-line vacuum comb with angled handle.

FIG. 6C illustrates an angle vacuum comb with angled handle and transition end.

FIG. 6D illustrates an in-line vacuum comb with angled handle and transition end.

FIG. 6E illustrates an in-line vacuum comb with standard hose size handle.

FIG. 6F illustrates an angle vacuum comb with standard hose size handle.

FIG. 6G illustrates an in-line vacuum comb with standard hose size angled handle.

FIG. 6H illustrates an angle vacuum comb with standard hose size angled handle.

FIG. 6I illustrates an in-line vacuum comb with standard hose size connection.

FIG. 6J illustrates an in-line vacuum comb with standard hose size angled connection.

FIG. 6K illustrates an angle vacuum comb with standard hose size connection.

FIG. 6L illustrates an angle vacuum comb with standard hose size angled connection.

FIG. 7 illustrates vacuum comb Samples of Odd-Shaped Transitions and Adapters.

FIG. 7A illustrates an angle vacuum comb with gradually transitioned handle.

FIG. 7B illustrates an angle vacuum comb with handle attached to a transition adapter.

FIG. 7C illustrates an in-line vacuum comb with transitioned handle end.

FIG. 7D illustrates a straight odd-shape transition adapter.

FIG. 7E illustrates a transitioned extension end.

FIG. 7F illustrates an elbow adapter.

FIG. 7G illustrates an elbow odd-shape transition adapter.

### REFERENCE NUMERALS IN DRAWINGS

101 Comb.
102 in-line comb housing.
103 Vacuum comb hollow handle.
104 Transition (from handle to vacuum hose connector).
105 Vacuum hose connector.
106 Angle comb housing.
107 Transition (from comb housing to handle).
108 Vacuum comb extension.
109 Extension coupler adapter connector.
110 Internal reducer adapter connector.
111 External reducer adapter connector.
112 Enlarger adapter connecter.
113 Straight odd-shape transition adapter for vacuum comb handle.
114 Elbow adapter/transition for vacuum comb handle.
115 Odd-shape transition adapter to odd-shaped vacuum inlets.
116 Gradually transitioned handle to an odd-shaped transition end.

### SUMMARY OF THE INVENTION

The present invention describes a method and apparatus to provide a cost effective economical way of making efficient Vacuum Combs where hair does not get entangled around comb teeth, that attach to standard vacuum hoses, making use of the vacuum equipment that a person already has, and/or use them with an adapter transition piece for use with portable smaller vacuums. In one embodiment of the present invention, the Vacuum Comb is utilized in pet grooming by attaching it to household vacuum and gliding it over the pet's hair/fur, and removing its loose hair and dandruff by combing, and drawing the lose hair into the vacuum bag or container, then disposing of that hair later.

Animal hair come in different length, and as a rule of thumb any hair/fur strand longer than ½″ will have the tendency to form a “U” shape around a comb's tooth or a brush's bristle). The problem of entangling arises if the two arms of the “U” point towards the direction of the vacuum suction flow, if this happens, then the hair/fur strand will form a hook around the comb's teeth or brush's bristles and anchor itself there, and as more hair do the same, the entangled hair will build up blocking the passage ways, dropping the efficiency, eventually choking the vacuum, and rendering it useless.

The key to prevent long hair from entangling and building up requires satisfying four conditions: 1—To have a rigid (or semi rigid) one row comb perpendicular to the flow direction. 2—The combing stroke should be in the same direction as the vacuum suction flow. 3—The long hair is collected with the base of the “U” pointing in the direction of the vacuum suction flow. 4—No obstacles are present between the combed hair and the vacuum suction inlet point. This concept is utilized in the design of the Vacuum Comb.

The In-Line Vacuum Comb is ideal for use on short hair (hair equal or shorter than ½″ long), because the short hair can't form a “U” around a comb's tooth with the vacuum's suction power pulling on it. Hence there will be no hair buildup blocking the passage ways, and therefore the unit will always function efficiently.

The Angle Vacuum Comb is ideal for use on long hair longer than ½″, because even if the hair tries to wrap around the comb's tooth, yet since the vacuum suction is applied on that same side as the hair, then the vacuum power constantly clears all combed long hair before they have the chance to get entangled. And the unit will always function efficiently.

The Extension Tubes are joined together with a coupler, and because they are made of increments, a person can adjust them to his/her height. They are ideal for use while standing up, reaching out to the floor, for cleaning up any pet hair fallout. Hence it doesn't cause strain to a person's back, due to its light weight and the avoidance of bending down.

A rigid extension tube with an elbow transition/adapter (or a built in elbow), connected to a Mini vacuum strapped to the shoulder is more handy (and less strain to the back) than using a flexible hose, when trying to pick hair/fur or dirt from the floor.

The Adapters allow the Vacuum Comb attachment head to be connected to a variety of vacuum hoses, or directly to different vacuum mouth inlets, through the use of different transition pieces.

### DETAILED DESCRIPTION

The following description describes the Vacuum Comb, as well as the way to assemble it. The following detailed description sets forth numerous specific details to provide a thorough understanding of the invention. However those skilled in the art will appreciate that the invention may be practiced without these specific details. In other instances, well-known methods, procedures, protocols, components, and items have not been described in detail so as not to obscure the invention.

Although particular embodiment of the invention will be discussed, with reference to making Vacuum Combs, those of ordinary skill in the art will appreciate that the present invention may be utilized in other types of applications. In particular the teachings of the present invention may be applied to other devices and applications.

The most economical way to manufacture the Vacuum Combs is by injection molding.

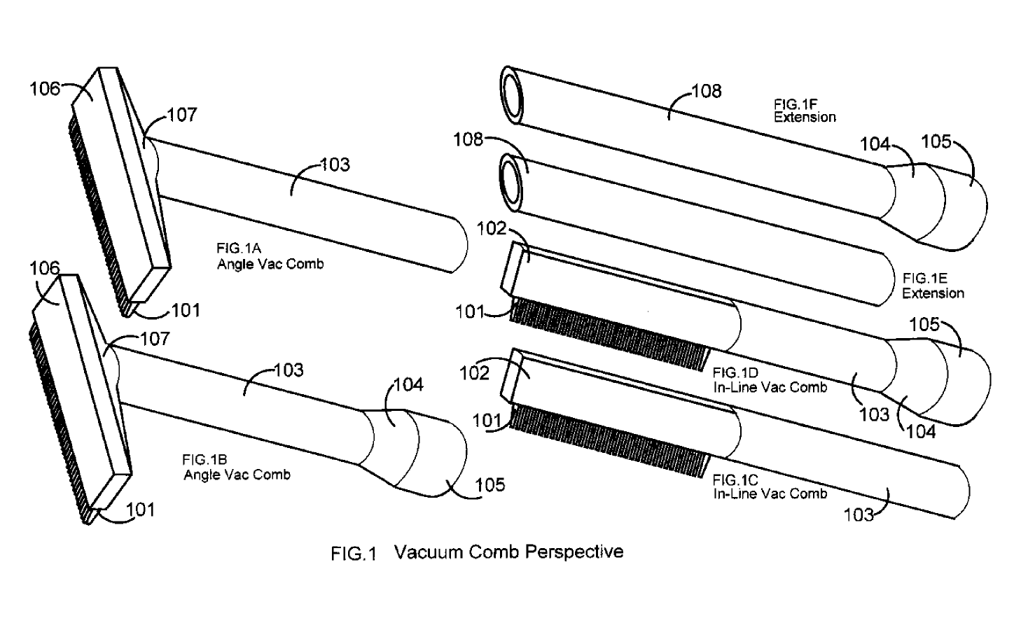

FIG. 1 illustrates an embodiment of the invention in which two styles of the Vacuum Combs are shown; the In-Line Vacuum Comb and the Angle Vacuum Comb (also known as the T-Shaped or Perpendicular Vacuum Comb), as well as Extension pieces, shown in perspective.

FIG. 1A illustrates an embodiment of an Angle Vacuum Comb consisting of; comb 101, comb housing 106, transition (from comb housing to handle) 107, and hollow handle 103.

FIG. 1B illustrates an embodiment of an Angle Vacuum Comb with a transition end, consisting of; rigid comb 101, comb housing 106, transition (from comb housing to handle) 107, hollow handle 103, transition (from handle to hose connector) 104, and vacuum hose connector 105.

FIG. 1C illustrates an embodiment of an In-Line Vacuum Comb consisting of; rigid comb 101, comb housing 102, and hollow handle 103.

FIG. 1D illustrates an embodiment of an In-Line Vacuum Comb with a transition end, consisting of; comb 101, comb housing 102, hollow handle 103, transition (from handle to hose connector) 104, and vacuum hose connector 105.

FIG. 1E illustrates an embodiment of a Vacuum Comb Extension consisting of; hollow extension tube 108.

FIG. 1F illustrates an embodiment of a Vacuum Comb Extension with a transition end, consisting of; hollow extension tube 108, transition (from extension to hose connector) 104, and vacuum hose connector 105.

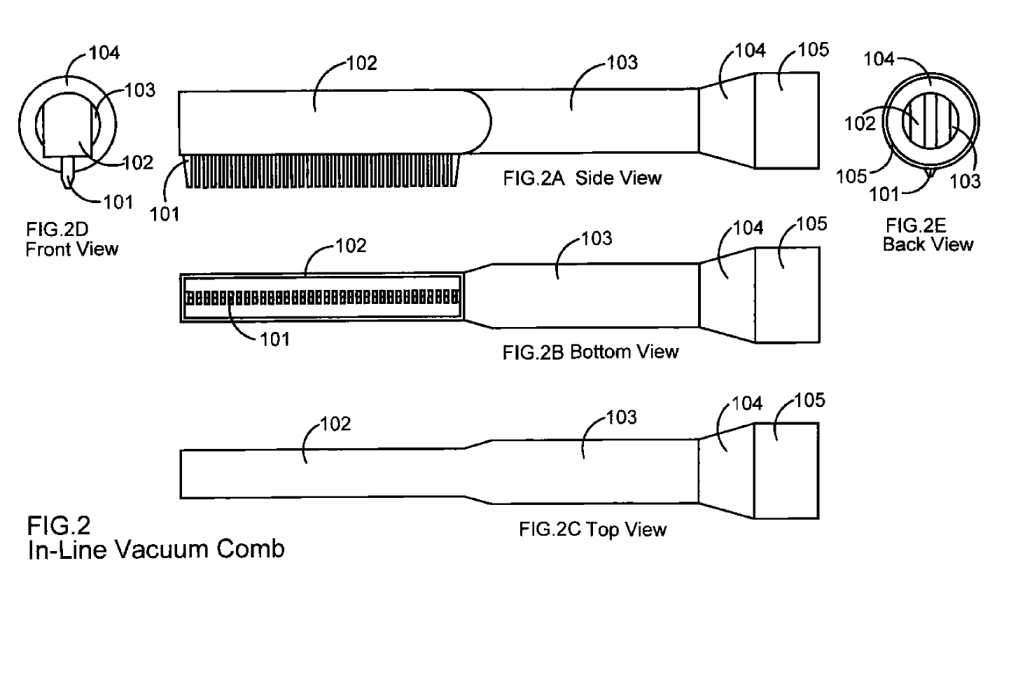

FIGS. 2, 2A, 2B, 2C, 2D & 2E illustrate embodiments of an In-Line Vacuum Comb with a transition end, in; side view FIG. 2A, bottom view FIG. 2B, top view FIG. 2C, front view FIG. 2D, and back view FIG. 2E. Consisting of; comb 101, comb housing 102, hollow handle 103, transition (from handle to hose connector) 104, and vacuum hose connector 105.

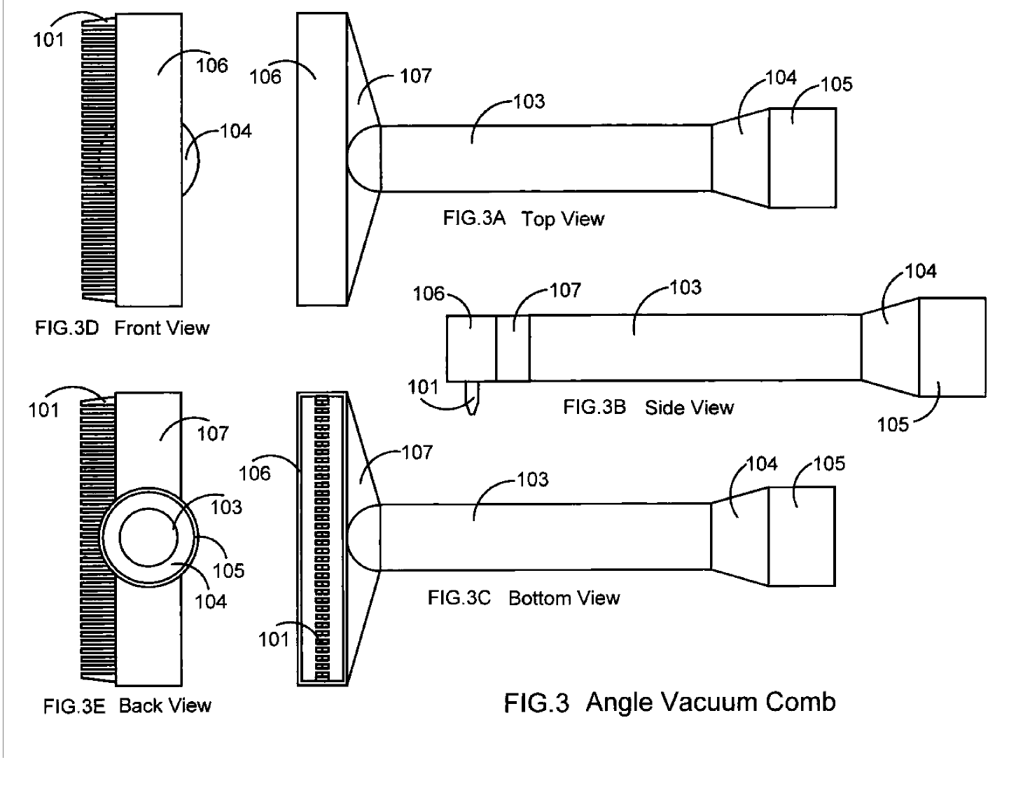

FIGS. 3, 3A, 3B, 3C, 3D & 3E illustrate embodiments of an Angle Vacuum Comb with a transition end, in; top view FIG. 3A, side view FIG. 3B, bottom view FIG. 3C, front view FIG. 3D, and back view FIG. 3E. Consisting of; comb 101, comb housing 106, transition (from comb housing to handle) 107, hollow handle 103, transition (from handle to hose connector) 104, and vacuum hose connector 105.

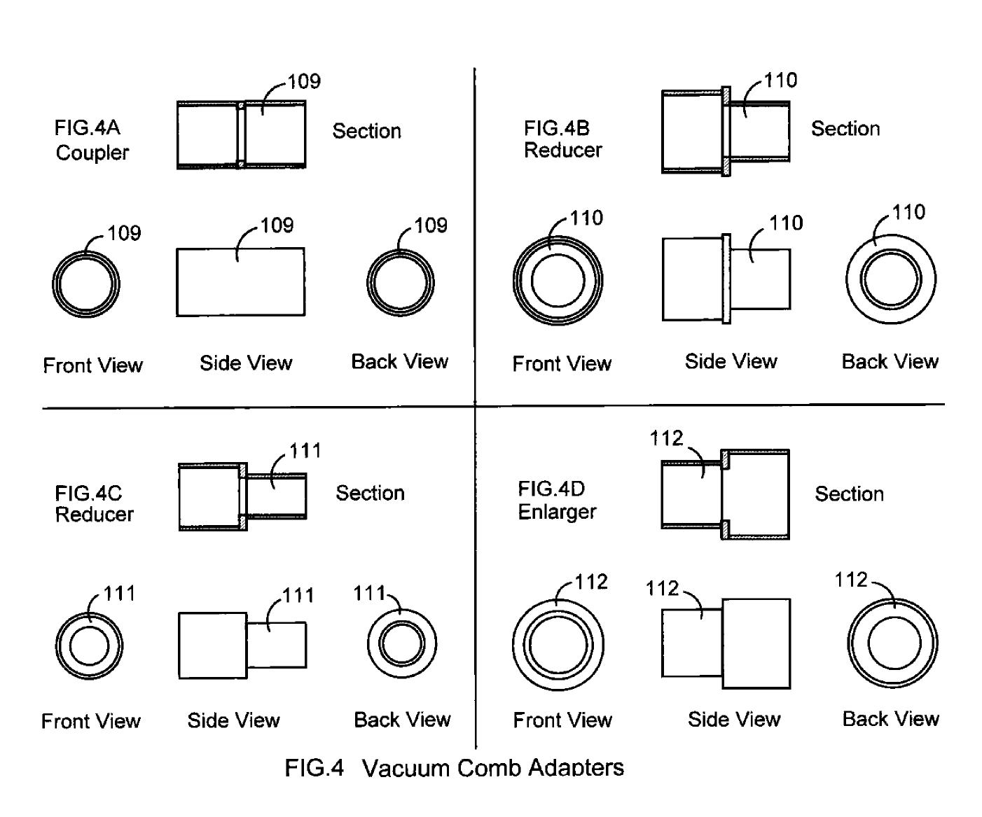

FIG. 4 illustrates an embodiment of different Adapters that allow the Vacuum Comb to be connected to different diameter vacuum hoses, vacuum mouth inlet, and/or extensions. Additionally odd shaped adapters can connect to vacuums with odd shaped mouths.

FIG. 4A illustrates an embodiment of a Coupler 109, which joins two extension tubes together, or a vacuum comb handle to an extension tube.

FIG. 4B illustrates an embodiment of an internal Reducer 110, which joins a vacuum comb hose connector to a smaller diameter vacuum hose.

FIG. 4C illustrates an embodiment of an External Reducer 111, which joins a vacuum comb handle to a smaller diameter vacuum hose.

FIG. 4D illustrates an embodiment of an Enlarger 112, which joins a vacuum comb handle to a larger diameter vacuum hose.

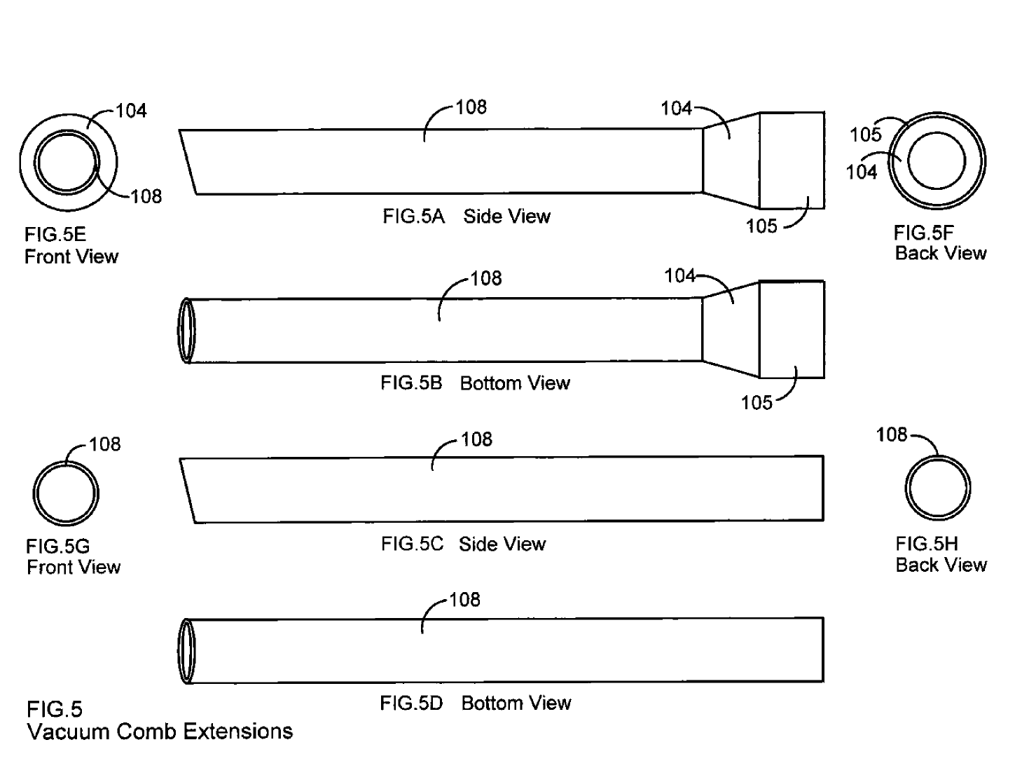

FIG. 5 illustrates an embodiment of Vacuum Comb Extensions.

FIGS. 5A, 5B, 5E, & 5F illustrate embodiments of a Vacuum Comb Extension with a transition end, consisting of; hollow extension tube 108, transition (from extension tube to hose connector) 104, and vacuum hose connector 105.

FIGS. 5C, 5D, 5G, & 5H illustrate embodiments of a Vacuum Comb Extension without a transition end, consisting of; hollow extension tube 108.

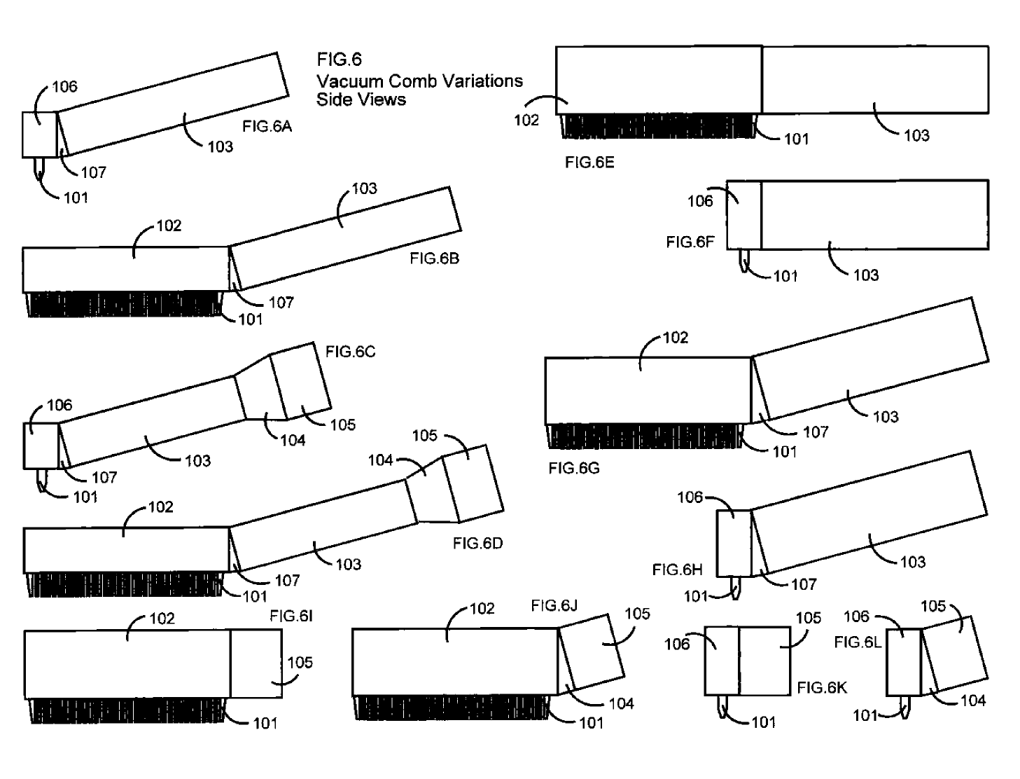

FIG. 6 illustrate different embodiments of Vacuum Combs Variations.

FIGS. 6A, 6C, 6F, 6H, 6K, & 6L illustrate different embodiments of an Angle Vacuum Comb respectively; with an angled handle FIG. 6A, with an angled handle and a transition end FIG. 6C, with a standard hose size handle FIG. 6F, with standard hose size angled handle FIG. 6H, with standard hose size connection but no handle FIG. 6K, with standard hose size angled connection but no handle FIG. 6L, and consisting of; comb 101, comb housing 106, transition (form comb housing to handle) 107, hollow handle 103, transition (from handle to hose connector) 104, and hose connector 105.

FIGS. 6B, 6D, 6E, 6G, 6I, & 6J illustrate different embodiments of an In-Line Vacuum Comb respectively; with an angled handle FIG. 6B, with an angled handle and a transition end FIG. 6D, with a standard hose size handle FIG. 6E, standard hose size angled handle FIG. 6G, with standard hose size connection but no handle FIG. 6I, with standard hose size angled connection but no handle FIG. 6J, and consisting of; comb 101, comb housing 102, transition (form comb housing to handle) 107, hollow handle 103, transition (from handle to hose connector) 104, and hose connector 105.

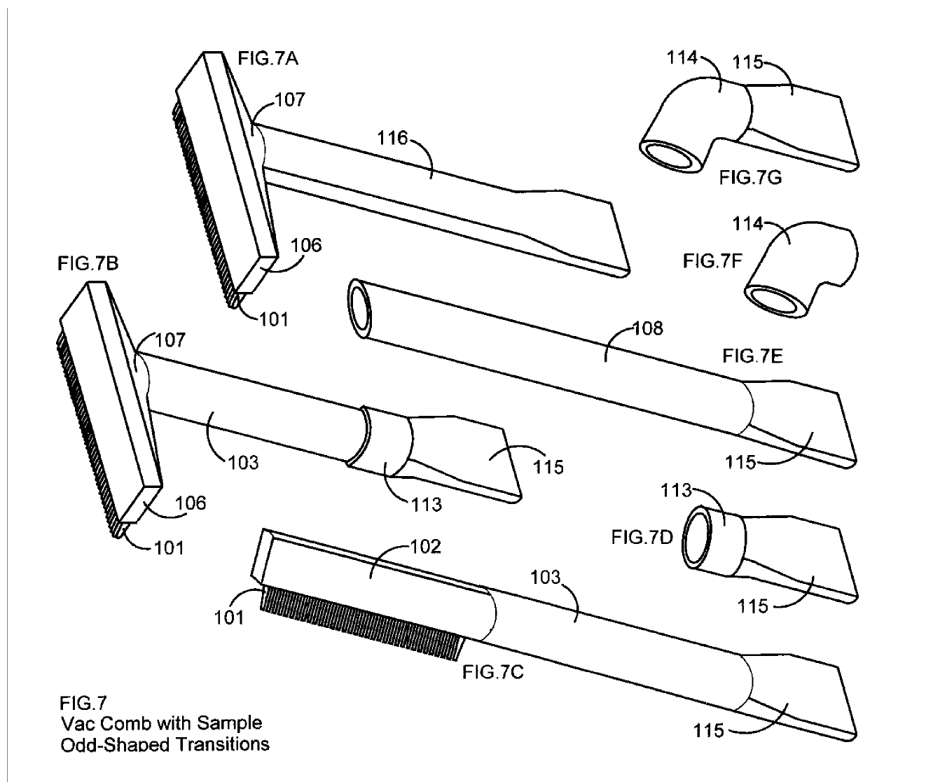

FIG. 7 illustrate different embodiments of Vacuum Combs Odd-Shaped transitions and adapters.

FIGS. 7A, 7B, 7C, & 7E illustrate different embodiments of transitions to odd-shaped ends; an angle vacuum comb with gradually transitioned handle FIG. 7A, an angle vacuum comb with handle attached to a straight odd-shape transition adapter FIG. 7B, an in-line vacuum comb with transitioned handle end FIG. 7C, and a transitioned extension end FIG. 7E.

FIGS. 7D, 7F, & 7G illustrate different embodiments of odd-shape transition adapters; a straight odd-shape transition adapter FIG. 7D, an elbow transition/adapter FIG. 7F, and an elbow odd-shape transition adapter FIG. 7F.

Assembling

The Vacuum Comb is made of a rigid comb that is attached to the end of a vacuum hose through the hose connector 105. To activate it, the vacuum machine is turned on creating a suction that draws in animal loose hair/fur and dandruff while grooming.

For vacuums hoses with small diameters (and some portable vacuums) the handle 103 could be attached directly to the vacuum hose without a transition piece.

In the case of using a small portable vacuum cleaner, different adapters could be used to offer the necessary transition, to match different manufacturer's hose diameters.

Adapters could also be made of different shapes to match the odd shaped mouths inlets of some small portable vacuum cleaners. Where they can be directly connected to the mouth of small vacuum cleaner.

The most economical material to make the Vacuum Comb from is plastic.

The most economical way to mass produce the Vacuum Comb is through the process of injection molding.

An alternate would be the use of a metal instead of plastic, which would be more expensive, but also more durable.

Another alternate would be having the housing made of rigid plastic and the comb of metal. The advantage of metal combs is that they could be made with fine spacing between the teeth, allowing it to clear fleas, and this way fleas and ticks could be combed and vacuumed from animals.

Another alternate would be having the housing made of rigid plastic while the comb teeth are made of semi rigid plastic, with rounded soft tip (i.e. soft yet firm). The advantage of this is that it allows flexibility and offers less pull on the hair/fur. This would be ideal for pets with shaggy hair/fur which is already entangled prior to combing such as; sheep dog, and sheep. Hence the flexible teeth will slightly bend (then springing back to its original position) as it combs.

### CONCLUSION

Accordingly, the reader will see the advantage of the Vacuum Comb which is a simple economical tool that can be used for a large variety of applications, one of which is animal grooming.

Although the description above contains many specifications, these should not be construed as limiting the scope of the invention but as merely providing illustrations of some of the presently preferred embodiment of the invention.

The scope of the invention should be determined by the appended claims and their legal equivalents, rather than by the examples given.

What is claimed is:

1. An article consisting of a vacuum head attachment, with a comb with housing, and a handle, having passage ways through them, wherein this article connects to the end of a vacuum hose, through proper inner and outer diameters, is powered by a vacuum machine, and is used for animal grooming.

2. An article for indoor air cleaning consisting of a vacuum head attachment, with a comb, and a handle, with passage ways through them, wherein this article connects to the end of a vacuum hose, through proper inner and outer diameters, is powered by a vacuum machine, and is used on animals to remove or reduce indoor air pollution, and allergens, by utilizing the suction power of the vacuum machine for grooming animals to remove their hair and dandruff, which are considered as indoor pollutants.

3. An article consisting of attachment head housing of a single row rigid comb that acts like a rake, and can deliver vacuum through its housing's passage ways, to dislodge loose hair/fur and dandruff, that are drawn into a vacuum bag or container of a powered vacuum cleaner, as the comb is run through the hair/fur of an animal.

4. An article consisting of a vacuum head attachment with a single row comb that is perpendicular to the vacuum flow direction, for grooming long haired animals.

5. An article consisting of a vacuum head attachment with a single row comb that is in-line to the vacuum flow direction, for grooming short haired animals.

6. A tangle-free animal grooming article consisting of a vacuum head attachment with a one row comb that is perpendicular to the vacuum flow direction, and with passage ways through its housing, wherein said comb when grooming animals, gets their long hair/fur strands oriented in a “U” shaped configuration, with the base of the “U” strands pointing towards the inlet of the vacuum hose connection, having a clear passage, with no obstacles in their way, getting the hair/fur sucked in and collected in a vacuum bag or container, when the vacuum is powered.

7. A tangle-free animal grooming article consisting of a vacuum head attachment with a one row comb that is in-line with the vacuum flow direction, and with passage ways through its housing, wherein said comb when grooming animals, allows their short hair/fur to slip around the comb teeth, and get sucked towards the inlet of the vacuum hose connection, with no obstacles in their way, getting the hair/fur sucked in and collected in a vacuum bag or container, when the vacuum is powered.

8. An article consisting of vacuum head attachment, with a single row rigid comb, with passage ways through its housing, and through the hollow rigid handle of sufficient length, and with proper inner and outer diameters, wherein its end attaches to the end of a vacuum hose, allowing it to draw in loose animal hair/fur and dandruff, when the vacuum machine is powered, while grooming animals.

9. The vacuum comb attachment of claim 8, wherein said article has firm yet flexible comb teeth.

10. The vacuum comb attachment of claim 8, wherein said article has the comb in-line with the flow direction.

11. The vacuum comb attachment of claim 8, wherein said article has the comb at an angle with the handle.

12. The vacuum comb attachment of claim 8, wherein said article is made of any material, or any combination of materials.
